(19) United States
(12) Patent Application Publication
(10) Pub. No.: US 2003/0012697 A1
(43) Pub. Date: Jan. 16, 2003

(54) Assembly microchip using microfluidic breadboard

(76) Inventors: Jong Hoon Hahn, Pohang-si (KR); Bong Chu Shim, Seoul (KR); Kyung Won Ro, Pohang-si (KR); Yong Min Park, Paju-si (KR)

Correspondence Address: David A. Einhorn, Esq., Anderson Kill & Olick, P.C., 1251 Avenue of the Americas, New York, NY, 10020, US

(21) Appl. No.: 10/197,515

(22) Filed: Jul. 16, 2002

(30) Foreign Application Priority Data
Jul. 16, 2001 (KR) 2001-42802

(51) Int. Cl. B01L 11/00; B32B 5/00

(52) U.S. Cl. 422/99; 422/100; 422/101

(57) ABSTRACT

A microfluidic breadboard comprises a plurality of pairs of openings formed on an upper surface of a substrate and arranged at regular intervals, wherein each pair of openings are connected to each other through a microchannel formed in the bulk of the substrate so that the microfluidic breadboard has an array of U-shaped microchannels.

An assembly microchip comprises a microfluidic breadboard having an array of U-shaped microchannels and a couple of modules, wherein the modules are reversibly or irreversibly bonded to the upper surface of the breadboard, and some of U-shaped microchannels of the breadboard are interconnected through the microchannels of the modules. Herein, the modules are designed to perform functions, such as injection, mixing, extraction, purification, concentration, dilution, reaction, synthesis, separation, and detection. In this way, we can make a variety of prototypes of microchips cheaper and faster because this does not require the photolithographic process, which facilitates designing of microfluidic chips through rapid optimization.

Therefore, the assembly microchip using the microfluidic breadboard of the present invention may be advantageously applied to manufacture in an economical way a multipurpose lab-on-a-chip which can be used in the field of chemistry, biotechnology, chemical/environmental engineering, etc.

### FIELD OF THE INVENTION

The present invention relates generally to the fields of chemical analysis and testing, and, more specifically, to a microfluidic breadboard for assembling a microfluidic chip having interconnected microchannels through which fluids can be delivered.

### BACKGROUND OF THE INVENTION

Recent development of microchip technologies has facilitated the fabrication of miniaturized chemical instruments. For instance, microchip devices have been used to perform liquid phase separations, e.g., electrochromatography and electrophoresis, and mix reagents in an integrated micro-reactor for chemical reactions.

Such microchips have many advantages over conventional bench-scale instruments, e.g., increased speed of analysis, reduced reagents consumption, and ready amenability to automation through computer control. These integrated devices are now being referred to as a “Lab-on-a-Chip”, as the operations of a complete wet chemical laboratory may possibly be integrated.

A lab-on-a-chip comprises a number of microchannels formed on a glass, silicon or plastic plate, through which fluids are delivered. The microchannels may each function as an injector, a reactor or a separator depending on the shape thereof. The flow in a channel may be controlled using an electroosmosis phenomenon induced by an electric field.

Typically, a lab-on-a-chip having microchannels formed on a glass or silicon plate is manufactured using a photolithographic method comprising the steps of preparing a mold having a relief pattern of channels and injecting a monomer or prepolymer into the mold for the polymerization thereof and forming channels in an intaglio pattern; or by impressing a plastic plate at a temperature over its Tg with a metal relief pattern to emboss channels in an intaglio pattern.

There have also been suggested some rapid prototyping methods, such as The production of masks with a laser printer and the laser direct writing.

However, with any of the conventional lab-on-a-chips, it is not possible to change the channel design once the microchannels are formed, and the use thereof is confined to the originally designed purpose.

Therefore, there has existed a need to develop a versatile microfluidic chip that can be easily modified and used for many purposes.

### SUMMARY OF THE INVENTION

Accordingly, it is a primary object of the present invention to provide an improved microchip assembled by using a microfluidic breadboard and a couple of modules which are designed to perform functions, such as injection, mixing, extraction, purification, concentration, dilution, reaction, synthesis, separation, and detection, the module being reversibly changeable to meet a new desired use.

In accordance with one aspect of the present invention, there is provided a microfluidic breadboard comprising a plurality of pairs of openings formed on an upper surface of a substrate and arranged at regular intervals, wherein each pair of openings are connected to each other through a microchannel formed in the body of the breadboard.

In accordance with another aspect of the present invention, there is provided an assembly microchip comprising a microfluidic breadboard having a number of U-shaped microchannels, wherein the modules are reversibly or irreversibly bonded to the upper surface of the breadboard, and some of U-shaped microchannels of the breadboard are interconnected through the microchannels of the modules. Herein, the modules are designed to perform functions, such as injection, mixing, extraction, purification, concentration, dilution, reaction, synthesis, separation and detection.

### BRIEF DESCRIPTION OF THE DRAWINGS

The above and other objects and features of the present invention will become apparent from the following description of the invention, when taken in conjunction with the accompanying drawings which respectively show:

FIG. 1: a top view of the microfluidic breadboard in accordance with a preferred embodiment of the present invention and a sectional side view of the microchannel thereof;

FIG. 2: a flow sheet of a process for manufacturing the inventive microfluidic breadboard chips using a photolithography method;

FIG. 3: examples of micropatterns of some modules to be combined with the inventive microfluidic breadboard to attain various channel designs;

FIG. 4: an example illustrating how a lab-on-a-chip can be constructed using the inventive microfluidic breadboard and modules in accordance with the present invention;

FIG. 5: examples of assembly microchips having various channel designs in accordance with the present invention; and

FIG. 6: the assembly microchip in accordance with the present invention having absorptiometric or electrochemical analysis means at the detecting port thereof.

### DETAILED DESCRIPTION OF THE INVENTION

The microfluidic breadboard of the present invention is provided with a plurality of pairs of openings arranged at regular intervals on the surface thereof, wherein each pair of openings are interconnected through a microchannel formed in the body of the breadboard.

In accordance with the present invention, modules which are designed to perform functions, such as injector, reactor, separator or detector, can be combined with the inventive microfluidic breadboard to assemble a chemical microprocessor having an optimized structure. Since the microchannels of the microfluidic breadboard of the present invention are isolated from each other, it is possible to combine each channel flexibly with the modules which are suitable micropatterns to confer particular functions thereto so as to satisfy the requirement of a new intended use.

Therefore, the microfluidic breadboard of the present invention may be advantageously applied to manufacture in an economical way a multipurpose lab-on-a-chip which can be used in the field of chemistry, biotechnology, chemical/environmental engineering, etc.

The microchannels of the microfluidic breadboard of the present invention are capable of transporting a fluid from one end to the other by capillary action or by the action of a pressure or electric field difference. The orientation of the microchannels may be unidirectional or skewed. For example, all microchannels may be oriented parallel or at right angles to each other.

The sectional view of microchannel may be a U-shaped tube, whose ends are open on one surface of the microfluidic breadboard, its trunk lying under the surface of the microfluidic breadboard.

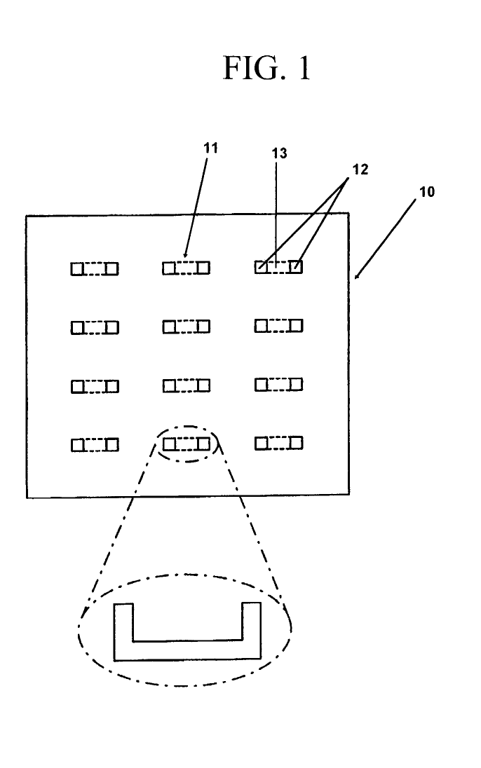

The microfluidic breadboard according to a preferred embodiment of the present invention is shown in FIG. 1: Microchannels (11) having a uniform shape and size are arranged in regular intervals and both ends of each microchannel (12) are exposed at the surface of the microfluidic breadboard (10) as a pair of openings. The dotted line (13) depicts the underlying channel beneath the surface of the microfluidic breadboard. The microchannel shown in FIG. 1 is U-shaped, and the cross section of the channel may be circlular, rectangular or square etc.

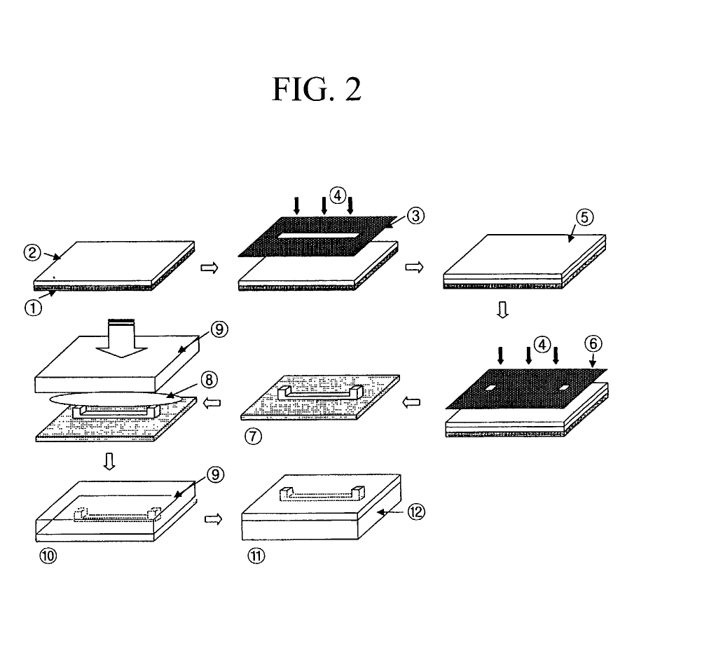

In accordance with the present invention, the inventive microfluidic breadboard may be fabricated using the photolithographic procedure shown in FIG. 2. A negative type photosensitive material (2) is applied to an upper surface of a silicon wafer (1). After the photosensitive layer is covered with a first photomask (3) having a desired channel pattern, UV (4) is applied over the photomask (3). The photomask (3) is removed and another layer of a negative type photosensitive material (5) is coated thereon to form a second layer. A second photomask (6) having a pattern that matches both ends of the channel is overlaid on the second layer and UV (4) is applied. After stripping, a solid mold (7) having the shape of the channel is formed. A molten polymeric material (8) is poured over the mold (7) and compressed by a pressure means (9) to form a polymeric upper plate (10) having an embossed channel. The polymeric upper plate (10) is then combined with a lower plate (12) to form the microfluidic breadboard (11) of the present invention. Alternatively, the upper plate may be prepared to have only the two opening shafts of the channel, and then, combined with a lower plate having on its surface a channel corresponding to the bottom part of the U-shaped channel.

The microfluidic breadboard may be formed by molding, embossing, machining, laser processing etc. The breadboard may be made of a flexible material such as silicone rubber or polymer, or a rigid material such as glass or silica.

The microfluidic breadboard of the present invention may be of the size of 0.5 mm×0.5 mm to 2 m×2 m, and each micro channel may measure 10 nm to 10 mm in width, 10 nm to 10 mm in depth and 10 μm to 10 cm in length. The intervals between two adjacent microchannels may be from 10 μm to 10 cm.

In use, the microfluidic breadboard in accordance with the present invention may be connected to one or more other microfluidic breadboards.

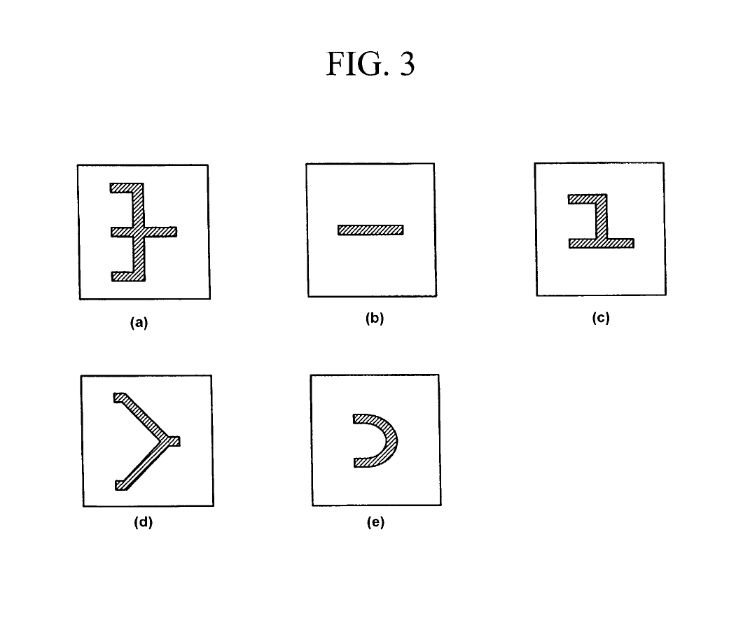

FIG. 3 shows various shapes of the micropatterns of modules that may be combined with the microfluidic breadboard of the present invention to provide an assembly microchip. Referring to FIG. 3, (a) cross represents injecting samples, (b) straight stands for separation, (c) T for reacting two reagents, (d) Y for a pre-column reactor where injection/separation is conducted after reaction, and (e) curve for extending column length.

The ends of the micropatterns of modules are designed to engage the opening ends of the microchannels exposed on the surface of the microfluidic breadboard of the present invention in a seal-tight manner so that a leak-proof interconnected channel system is formed. The microfluidic breadboard and the modules may be coupled in a reversible or irreversible way.

A module may comprise an upper plate having a plane surface and a lower plate having an exposed microchannel formed on a upper surface thereof and some openings, which are sited at the ends of the microchannel, passing through the thickness thereof, and the plane surface of the upper plate being tightly bonded with the upper surface of the lower plate. Alternatively, a module may comprise an upper plate having an exposed microchannel formed on the lower surface thereof and a lower plate having some openings, which are sited at the ends of the microchannels, passing through the thickness thereof, and one surface of the lower plate being tightly bonded with the lower surface of the upper plate, may be used.

Using the microfluidic breadboard of the present invention, it is possible to easily construct a channel design having a specific function, or an integrated channel system having various functions, e.g., injection, mixing, extraction, purification, concentration, dilution, reaction, synthesis, separation and detection etc. Further, specific parts of the channel system so formed may be modified by loading therein gel, bead composition or viscous polymer solutions, or by surface treating said parts to impart different properties, e.g., hydrophilic, hydrophobic and electrochemical properties.

The inventive assembly microchip may be furnished with one or more containers for samples collected from the system or solutions that may be fed, e.g., a buffer solution which may be used for controlling the fluid flow. The containers and the channel system may be coupled in a reversible way using the techniques known in the art.

The present invention is further described and illustrated in the following Examples, which are, however, not intended to limit the scope of the present invention.

### EXAMPLE 1

According to the procedure shown in FIG. 2, a microfluidic breadboard of poly(dimethylsiloxane; PDMS) was prepared as follows.

A negative type photoresist SU-8 (MicroChem Corp., Newton, Mass., USA) (2) was spincoated on a silicone wafer (1) to a thickness of 40 μm, and UV was irradiated thereon through a first photomask (3) having a projected pattern of microchannels. After heating and cooling in an oven, another layer of SU-8 (5) was spincoated over the first layer to a thickness of 80 to 100 μm. A second photomask (6) having a pattern matching the openings of the channel ends was put on the second layer and exposed to UV.

When the wafer was developed, a relief mold (7) having the shape of microchannels was obtained. Prepolymer PDMS (8) was poured on the mold and crosslinked under pressure. The pressure was applied by using a PDMS plate (9) whose surface had been oxidized using a tesla coil and treated with 5 μl of silanization solution for 1 hr in a vacuum chamber. A PDMS membrane having a thickness equal to the channel height and having an intaglio channel pattern was obtained by compression molding. The PDMS membrane (10) obtained after removing the pressure plate (9) and the relief molding was combined with another PDMS substrate (12) by means of oxidation using the tesla coil, to obtain a microfluidic breadboard.

Each of the microchannel comprised a horizontal channel of 6 mm in length, 50 μm in width and 40 μm in depth, and two vertical rectangular channels connected to the ends thereof measuring 80 to 100 μm in height, 50 μm×40 μm in cross sectional dimension. The intervals between the U-shaped channel rows thus formed were 6 mm in both the X and Y directions.

### EXAMPLE 2

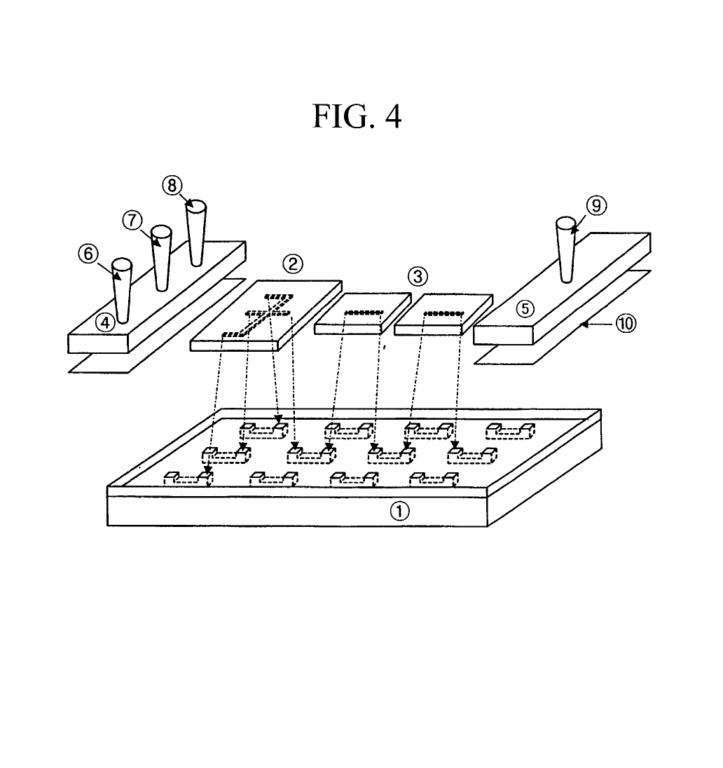

FIG. 4 shows a process for combining the microfluidic breadboard of Example 1 with various modules to construct a lab-on-a-chip. Referring to FIG. 4, the ends of patterns 2 and 3 were connected to the channel openings of the microfluidic breadboard using a microscope to provide a leak-tight microfluidic channel system. Reservoirs for providing a buffer solution and a sample (6 and 7, respectively) and reservoirs for receiving the discharged buffer solution and sample (8 and 9, respectively) were connected to the channel system. Glass plates (4 and 5) each of 14 mm×10 to 20 mm having one or 3 holes of 3 mm were used as reservoirs holders, and tips of 200 μl pipet, as reservoirs. The holders fitted with containers were disposed on the microfluidic breadboard using a double-sided adhesive tape (10) so that such adhesive mounting of the containers could be removed later.

### EXAMPLE 3

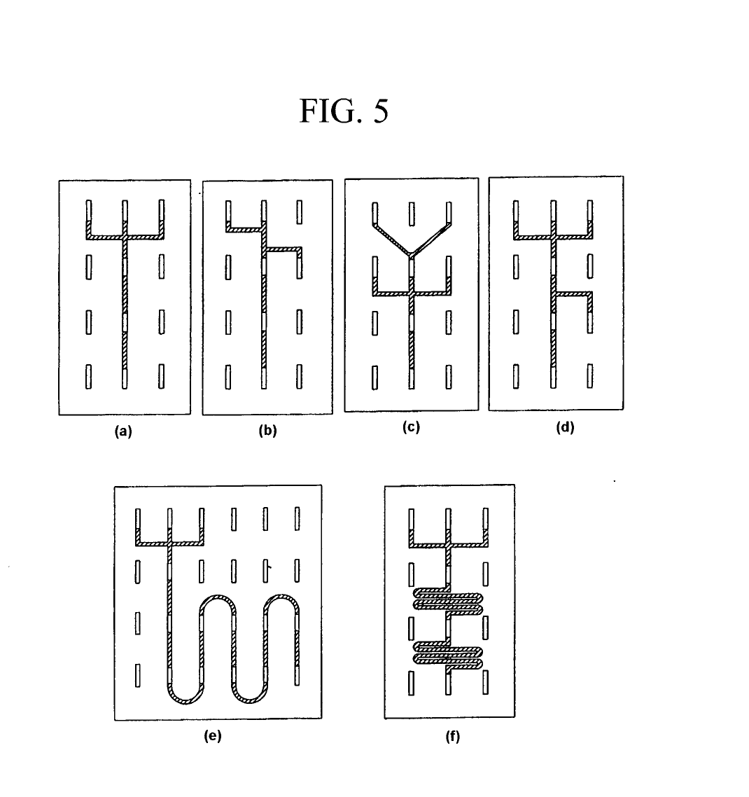

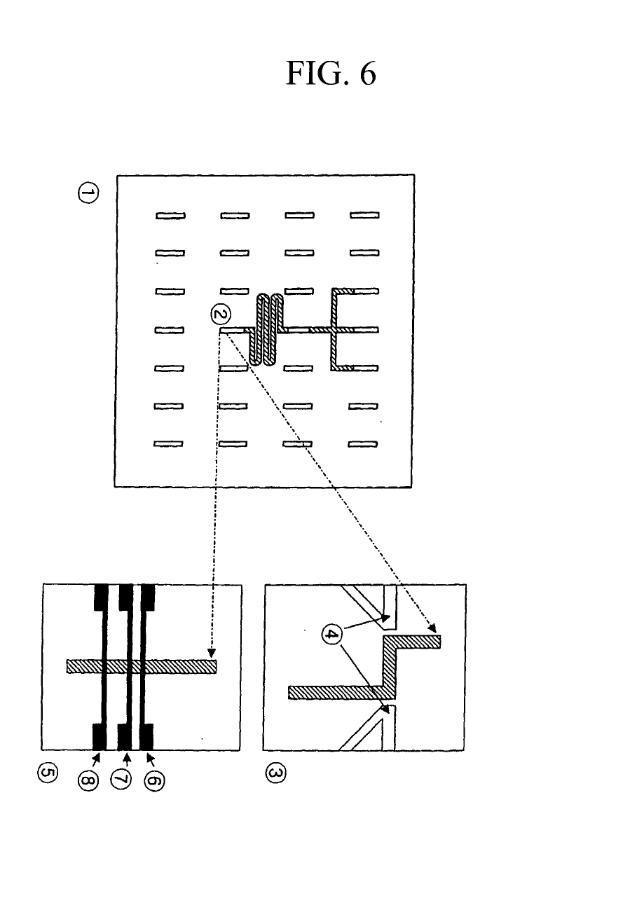

The inventive microfluidic breadboard is capable of providing various chemical microprocessors when it is combined with suitable modules for injection, reaction and detection. For example, referring to FIGS. 5 and 6, (a) represents a general separation chip, and (b), a modification thereof for constant injection. (c) is a chip to be used when a reaction between samples is required before injection, and (d) shows a modification thereof so that a reaction is conducted after injection. Further, the length of a separation column can be easily adjusted as in (e) or (f).

In addition, the detection part may also be adjusted. For example, while a fluorescence analysis is usually conducted with a chip having a straight channel, an absorptiometric or electrochemical analysis may be performed with the cross-shaped chip shown in FIG. 6. Referring to FIG. 6, when the end of the channel (2) is combined with detection part (3), the chip may be used for absorptiometric analysis using two optic fibers (4), one connected to a light source and the other, to a detector such as an optic amplifier. Meanwhile, when the end of channel (2) is combined with detector part (5), the chip may be used for electrochemical analysis, wherein (6), (7) and (8) are working, spare and standard electrodes, respectively.

As can be seen from the above, the inventive microfluidic breadboard can be advantageously used in assembling a lab-on-a-chip having a complex design in an economical way. Such an assembled lab-on-a-chip may be easily modified or altered when needed.

While some of the preferred embodiments of the subject invention have been described and illustrated, various changes and modifications can be made therein without departing from the spirit of the present invention defined in the appended claims.

What is claimed is:

1. A microfluidic breadboard comprising a plurality of pairs of openings formed on the upper surface of a substrate and arranged at regular intervals, wherein each pair of openings are connected to each other through a microchannel formed in the body of the breadboard.

2. The microfluidic breadboard of claim 1, wherein the microchannel is a U-shaped channel having open ends at the upper surface of the breadboard.

3. The microfluidic breadboard of claim 1, wherein the microchannels are arranged in an orderly array.

4. The microfluidic breadboard of claim 1, wherein the microchannels are arrayed in different regions with difference in regularity.

5. The microfluidic breadboard of claim 1, wherein the substrate comprises an upper plate and a lower plate having a plane surface, the upper plate having a plurality of pairs of openings passing through the thickness thereof and exposed microchannels formed on a lower surface thereof, and the plane surface of the lower plate being tightly bonded with the lower surface of the upper plate so that U-shaped channels are formed therebetween.

6. The microfluidic breadboard of claim 1, wherein the substrate comprises an upper plate having a plurality of pairs of openings passing through the thickness thereof and a lower plate having exposed microchannels formed on the upper surface thereof, one surface of the upper plate being tightly bonded with the upper surface of the lower plate so that U-shaped microchannels are formed therebetween.

7. The microfluidic breadboard of claim 1, wherein the breadboard is made of rubber, polymer, glass or silica.

8. The microfluidic breadboard of claim 1, wherein the breadboard is prepared by molding, embossing, machining or laser processing.

9. The microfluidic breadboard of claim 1, wherein the breadboard measures 0.5 mm×0.5 mm to 2 m×2 m, each microchannel measures 10 nm to 10 mm in width, 10 nm to 10 mm in depth and 10 μm to 10 cm in length, and the interval between adjacent microchannels is from 10 μm to 10 cm.

10. An assembly microchip comprising a microfluidic breadboard of claim 1 having an array of U-shaped microchannels and one or more modules, wherein the modules are reversibly or irreversibly bonded to the upper surface of the breadboard, and some of U-shaped microchannels of the breadboard are interconnected through the microchannels of the modules.

11. The assembly microchip of claim 10, wherein each module has microchannels on its lower surface.

12. The assembly microchip of claim 10, wherein the module comprises an upper plate having a plane surface and a lower plate having an exposed microchannel formed on a upper surface thereof and some openings, which are sited at the ends of the microchannel, passing through the thickness thereof, and the plane surface of the upper plate being tightly bonded with the upper surface of the lower plate.

13. The assembly microchip of claim 10, wherein the module comprises an upper plate having an exposed microchannel formed on the lower surface thereof and a lower plate having some openings, which are sited at the ends of the microchannels, passing through the thickness thereof, and one surface of the lower plate being tightly bonded with the lower surface of the upper plate.

14. The assembly microchip of claim 10, wherein specific parts of the microchip are modified by loading therein gel, bead composition or viscous polymer solutions, or by surface treating said parts to impart different properties.

15. The assembly microchip of claim 10, wherein the modules are designed to perform a function selected from the group consisting of injection, mixing, extraction, purification, concentration, dilution, reaction, synthesis, separation and detection.
